(19) United States
(12) Patent Application Publication
(10) Pub. No.: US 2014/0345570 A1
(43) Pub. Date: Nov. 27, 2014

(54) METHOD OF FUEL ACTIVATION AND SYSTEM TO DELIVER IT TO A DIESEL ENGINE

(71) Applicant: HELPFUL TECHNOLOGIES, INC., Fort Lauderdale, FL (US)

(72) Inventors: Victor GURIN, Rochester, NY (US); Mindaugas MACIJAUSKAS, Boca Raton, FL (US); Serguei PERMIAKOV, Kanata (CA)

(21) Appl. No.: 14/457,021

(22) Filed: Aug. 11, 2014

Related U.S. Application Data
(62) Division of application No. 13/585,683, filed on Aug. 14, 2012.
(60) Provisional application No. 61/523,622, filed on Aug. 15, 2011.

(51) Int. Cl. F02D 41/38

(52) U.S. Cl. CPC F02D 41/3827
USPC 123/456

(57) ABSTRACT

A method for activating a diesel fuel by saturating it with air, CO₂ or any other type of gas and system to deliver it to an internal combustion engine (gas turbine, diesel engine or any HC fuel combustion unit) for combustion. The high pressure pump delivers the fuel from the fuel tank to the top of an absorber through at least one nozzle dispersing it. The compressed air is directed in the same absorber from the side of it wall, mixing it with dispersed fuel. The fuel with dissolved gas is called activated fuel. Activated fuel from the bottom of the absorber is directed to the fuel rail of a diesel engine by recirculation low pressure pump through the pressure regulating valve and Y-connector. Excessive fuel from the diesel engine is directed to the separator through the heat exchanger and then through the pressure regulator goes through the Y-connector, where it is mixing with fresh activated fuel from the absorber. The escaped gas in the return fuel line is separated in the gas separator. The system is running absolutely independently and can be easy turned off and switched to the base fuel supply. Even, if system accidentally loose power, it automatically switches to base fuel supply system. Switching from one system to another is very smooth without any interruption of engine operation.

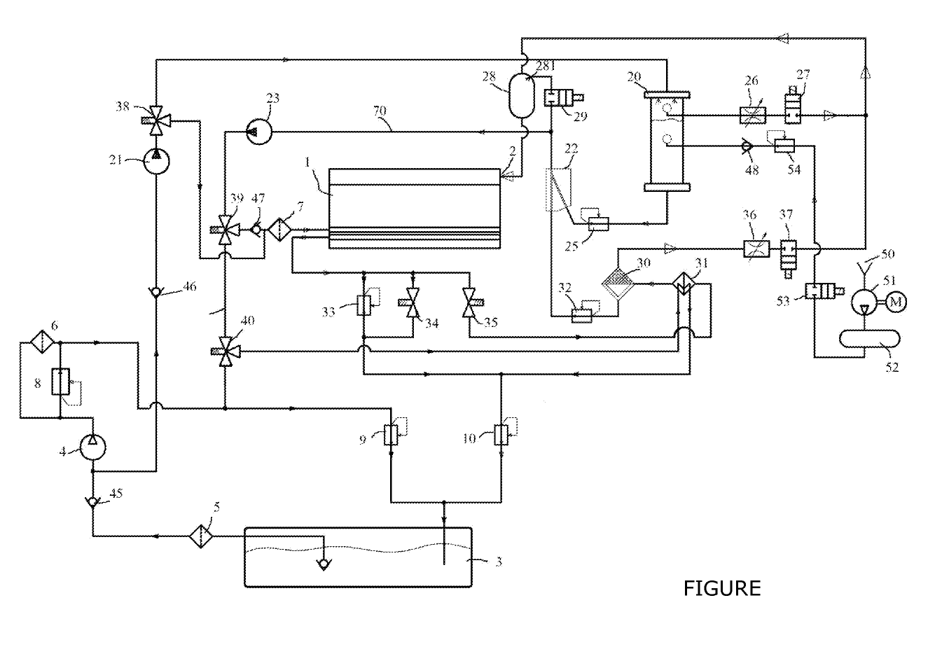

### CROSS-REFERENCE TO RELATED PATENT APPLICATION

This application claims priority based upon provisional application 61/523,622, filed on Aug. 15, 2011.

### FIELD OF INVENTION

The present invention relates to liquid fuel combustion and, more particularly, to the preparation of liquid fuels to combustion in a heavy-duty diesel engines.

### BACKGROUND OF THE INVENTION

The present invention relates to the field of the internal combustion engines and fuel delivery systems. The purpose of this invention is to prepare fuel/gas solution and deliver it to the fuel rail of a diesel engine. When fuel/gas solution flow through the nozzles the pressure in this stream fell significantly, preparing condition for intensive evaporation of the dissolved gas. Then, after fuel/gas solution dispersed in the combustion chamber, where temperature is much higher, the gas bursts (or explodes) out of each droplet of fuel and brakes it on thousands of smaller parts increasing the surface of contact with oxygen in many times thus increasing speed of flame propagation.

There are many patents describing methods of dissolving gases in liquid fuel and systems to deliver it to the combustion chamber. There are two methods to dissolve gas into liquid fuel: dissolving gas at high pressure in thin film of fuel, and in the smallest, as possible, droplets of liquid fuel. For instant, the use of nozzles to disperse fuel is described in Russian Pat. #2129662, of Feb. 2, 1998, U.S. Pat. No. 7,523,747, of Apr. 28, 2009 and both methods, nozzles and thin film of fuel, in U.S. Pat. No. 6,273,072, of Aug. 14, 2001 and in some late patents. The described systems require special devices that supposed to work within a certain range of parameters and at the same time certain conditions should be observed to provide the fuel/gas solution to the combustion chamber in proper condition. In practice it is difficult to satisfy both of these requirements simultaneously, and the achieved effect is not stable at varying loads.

U.S. Pat. No. 8,097,849 of Nov. 18, 2011 describes a system where returning fuel/gas solution is directed to a gasification vessel. Because amount of returning fuel is 4-7 times more than amount of fuel consumed by engine under regular load, increase of temperature in the gasification vessel is inevitable. High temperature of returning fuel decreases solubility of gas, which significantly decreases efficiency of this technology. Also it is impossible or very difficult to provide air cooling fuel from about 180° F. to 85° F.

### SUMMARY OF THE INVENTION

The main purpose of this invention is to deliver highly activated (maximum saturated) fuel to combustion chamber of an internal combustion engine without any free gas phase.

According to Henry's low the concentration of gas dissolved in the liquid is proportional to the pressure and inversely proportional to the temperature, which means that any increase of temperature at the time of saturation decrees amount of gas we can dissolve in liquid fuel. In the system presented here hot returning fuel/gas solution from engine after two-circuit heat exchanger and separator goes through the back pressure valve and Y-connector, where it is mixing with the fresh fuel from an absorber and then is pumped by recirculated pump to the engine. The separator, which removes escaped gas, is an additional element presented in this invention. In invention presented here the returning fuel is mixed with fresh activated fuel in Y-connector and then directed to the engine pressurized by recirculating pump to a pressure that is about 10% higher than the gas pressure in the absorber at the moment of fuel activation.

Any gas, which, in spite of all precaution, escapes from activated fuel in absorber or the returning fuel and separated I in the separator, flows along a line to a vapor/gas collector, which is incorporated in an air duct preferably downstream a turbocharger. Also the vapor/gas collector has at least one nozzle fluidically connected with a Y-connector to inject a pilot portion of the activated fuel in the air that is fed to the engine cylinders. Removing of escaped gas from absorber and separator and delivery it together with small amount of activated fuel to the engine is another technique, which distinguish this system from the system presented in U.S. Pat. No. 8,037,849.

Disclosed herein too is a system that includes two separate fuel supply contours that used to supply either untreated or activated fuel to the engine. This disclosure includes embodiments that may relate to a system that uses the method.

### BRIEF DESCRIPTION OF THE DRAWING

Figure is an exemplary depiction of a system for fuel activation and delivering it to an internal combustion engine according to the present invention.

### DETAILED DESCRIPTION

Disclosed here embodiments that relate to a method of fuel activation for combustion. This disclosure includes embodiments that relate to a system that uses the method. Activated fuel, at the time of injection, evaporates and burns much faster. Thus, injection of activated fuel must be performed at 5.5°-8.5° later, then untreated fuel.

Exemplary embodiments of the system are shown for locomotive heavy-duty engine. This system has two separate fuel supply contours that used to supply either untreated or activated fuel to the engine. There are two main operating modes: base and economical. At idling, starting or stopping the engine a base mode is used as it is hardly possible to provide efficient economical combustion of the activated fuel in these conditions. An activated fuel is used at high power loads where it provides a beneficial combustion that saves fuel and reduces emissions.

Now refer to a Figure that depicts a preferred embodiment of the system according to the present invention. A diesel engine 1, a fuel tank 3, a strainer 5, check valve 45, a fuel pump 4, a primary filter 6 with bypass valve 9 and engine mounted double element filter 7 that belong to a standard engine fuel supply system (called base fuel supply contour in this invention). An economical fuel supply contour comprises following main components: an absorber 20, a boost pump 21, a Y-connector 22, a recirculating pump 23 a gas separator 30, a gas/fuel vapors collector 28 with nozzle 281, a gas compressor 51, and receiver 52. Ball valves, solenoid valves and relieve valves that belong to this contour are described below.

In the base mode the fuel is drawn from the fuel tank 3 by the motor driven fuel pump 4 through the strainer 5 to filter out large solid particles. From the pump 4 the fuel is forced through the primary filter 6 to the engine mounted double element filter 7 which filter out small particles up to 2 microns. The 30 psi bypass valve 8 is connected across the primary filter 6. If the primary filter 6 becomes plugged, fuel bypasses and imposes the total filtering on the filter 7. A pressure relief valve 9 maintained the fuel flow pressure in the fuel line after the fuel pump 4 at about 65 psig. After passing the filter 7 the fuel flows through fuel rails of the engine. Theses rails supply fuel to injectors (not shown). The excess fuel, not used by the injectors, returns to the fuel tank 3 through a normally open ball valve 34 and a pressure relief valve 10 that creates back pressure, thus maintaining a positive supply of the fuel to the injectors.

In the economical mode the boost pump 21 draws the fuel from the fuel tank 3 through the strainer 5, pressurizes to around 400 psi and feeds it to the absorber 20. Nozzles installed in the absorber sprays the fuel in gas environment. Thus the gas dissolves in the fuel creating fuel/gas solution which we call activated fuel. The compressed gas comes to the absorber 20 from the gas compressor 51, the pressure regulating valve 54 maintained the gas pressure in the absorber 20 at around 185 psi. The recirculating pump 23 pumps the activated fuel along a line 70 from the absorber 20 through Y-connector 22 and the filter 7 to the engine 1.

A small amount of the activated fuel taken from the line 70 downstream the Y-connector 22 is injected by nozzle 281 in the air stream preferably at an inlet of the turbocharger (not shown) as a pilot portion of the fuel charge. The content of pilot portion in the air s less than 1.5% (preferably 0.35±0.05%). The purpose of the pilot portion is to facilitate the ignition of the main fuel charge upon injection in the combustion chamber. The pilot portion easily heat up during the compression stroke and begins burning by the moment of the injection of the main fuel charge.

With the activated fuel upon injection in the combustion chamber in addition to the hydrodynamic fuel atomisation a violent degassing takes place providing continuous breaking up of fuel microdroplet to a fine “nano” sizes. The combination of the gas desorption from the fuel solution with the hydrodynamic breaking-up of the injected fuel provides a fundamentally new process of the fuel atomization in the combustion chamber. The fuel microdroplets continuously break up to significantly small sizes providing an extremely high interfacial curvature and liquid vapour (fuel) pressure increases in as much as 8-10 times. This effect is described by the Kelvin equation and it is well known that the quicker liquid fuel evaporates the more rapid and effective the combustion of the gasoline or diesel is. One more important additional effect of the new injection process: the continuous chain breaking of the fuel droplets caused by the gas desorption prevents coalescence of the droplets and formation of the fuel film on the walls of the combustion chamber. As a result more fuel surface is available for contact with the air. Thus the fuel burns faster and more complete giving less harmful emissions.

The excess hot fuel flows through the two-circuit heat exchanger 31 where it cools down. The untreated fuel flow is used as a coolant in the heat exchanger 31. As in returned activated fuel flow outside the engine some gas can be released, the cooled fuel flows to the gas separator 30 where it settles for some time so any free gas/fuel vapors presenting in the activated fuel can be separated. The free gas/fuel vapors collects at top part of the gas separator and at the bottom is only liquid without any free gas phase. The liquid fuel from bottom part of the gas separator 30 flows to the Y-connector 22 where it mixes with the fresh activated fuel flow from the absorber 20. The Y-connector 22 is designed to exclude flow pulsations and stagnant zone and prevent free gas release at moment of flows mixing. The mixed flow of the activated fuel is directed to the engine 1 for combustion as described above.

Escaped gas and fuel vapors from the gas separator as well as gas environment is purged to air duct of the engine preferably upstream the turbocharger for burning. The purging is fulfilled upon a signal from low level sensors in both the gas separator and absorber for 2-3 sec.

To provide the operation of the system and switch between the operational modes electronically controlled normally open and closed ball valves and solenoid valves are used. Ball valves 38, 39, 40 and 34 are normally open, all other valve are normally closed. They are controlled by a controller (not shown). Check valves 45, 46, 47, and 48 are used to prevent the fuel to flow in wrong direction.

In the base mode all valve are de-energized and normally open ball valves 39 and 40 direct the untreated fuel to the engine. The normally open two-way ball valve 34 provides draining of the return fuel flow to the fuel tank.

In the economical mode all valves are energized except normally open three-way ball valve 38 and solenoid valves 27 and 37. Also the controller energizes the boost pump 21, recirculation pump 23, and gas compressor 51. Solenoid valves 27 and 37 are used to purge the absorber 20 and gas separator 30 upon signals from low level sensors accordingly. The valve 38 is usually de-energized and used only in emergency situations. A solenoid valve 29 that control the amount of fuel injected in the air stream as the pilot portion. The frequency of opening of this valve is set by signals from microcontroller of an engine that controls the air flow to the engine depending on the power loads.

The controller also provides a transitional mode that is used for switching over from economical mode to base mode. The purpose of the transitional mode is to prevent a free gas phase appearing and replace an activated fuel by fresh untreated fuel in fuel supply lines connected to the engine. The duration of this mode is adjusted between 5 to 60 seconds depending on engine.

In the transitional mode the controller does the following:

de-energizes the recirculation pump 23;

keeps energized the boost pump 21 and energized the three-way valve 38 thus redirecting the untreated fuel from the absorber 20 to the engine inlet to replace the activated fuel by the untreated fuel in filter 7, engine fuel rails and return fuel line;

keeps energized normally open valve 34 and de-energized normally closed valve 35 (both valves are closed), so the fuel flow through the pressure relieve valve 33 that keeps upstream maximum pressure;

after set time for the transitional mode the boost pump 21, valves 38, 39, and 40 are de-energized, and the fuel is supplied to the engine through base fuel supply contour.

The method and the system according to the present invention were tested on locomotive diesel engine EMD-645, 3745 hp, 16-cylinder. The system effectively operated in close-loop contour including the engine. The activated fuel recirculated and consumed fuel was refilled by newly prepared in the absorber. The gas for dissolving in the fuel was fed to the absorber at 180±3 psig. The fuel was delivered to nozzles for dispersing in the absorber at 315±15 psig. The recirculating pump and pressure reducing valve (32 in Figure) provided the flow of the activated fuel to the engine at 8±0.3 GPM and 235±5 psig. The returned excess fuel was effectively cooled down from 180±5° F. to 105±5° F. As a coolant the fuel from fuel tank (85±5° F.) was used. The returned fuel flow was mixed with fresh activated fuel from absorber in the Y-connector and directed to the engine.

The engine effectively operating on lean activated fuel/air mixture.

Several tests gave the following results:

a) Fuel economy improvement 8.1% to 14,4%;

b) Total emissions decrease up to 16%

c) by emission components

NOx emission decreased 9.5% to 16.3%

CO2 emission decreased 8.1% to 13.7%

CO emission decreased up to 15%

HC emission decreased up to 11.5%

It is understandable that the present invention was not e construed as limited to the forms shown which are to be considered illustrative rather than restrictive.

1-9. (canceled)

10. A method of effective fuel combustion for a diesel engine comprising:
mixing a pilot portion of a pre-activated fuel with air;
feeding a resulting lean air/fuel mixture into an engine cylinder and compressing to a high pressure during the compression stroke of a piston;
injecting a main portion of the fuel pre-activated by gases into the engine cylinder for combustion;
cooling down and separating an excess fuel not used for combustion from engine from free gas/fuel vapors and forming a separated excess fuel, and mixing the separated excess fuel with fresh pre-activated fuel then feeding to the engine.

11. The method according to claim 10, comprising activating the fuel to be supplied to the engine by diluting a gas or gases in it under relatively high pressure up to 250 psi.

12. The method according to claim 11, wherein gas to be diluted in the fuel is air, CO₂, exhaust gases, natural gas, hydrocarbon gases or a mix of any of these gases.

13. The method according to claim 10, comprising keeping the pre-activated fuel in the supply lines to the engine under pressure that is up to 15% higher than the gas pressure at fuel activation.

14. The method according to claim 10, further comprising injection timing of the main pre-activated fuel portion that is up to 8.5° angle retarded compared to standard fuel injection timing angle.

15. The method according to claim 10, comprising venting and introducing a free gas and fuel vapors separated into an airflow.

16. The method of effective fuel combustion for high-duty diesel engine according to claim 10 wherein the composition of the lean air/fuel mixture is up to 1/0.015.

17. The method according to claim 10, wherein the mixing takes place at an air intake duct upstream of a turbocharger.

18. The method according to claim 15, comprising venting and introducing a free gas and fuel vapors separated into airflow upstream of a turbocharger.
